(19) United States
(12) Patent Application Publication
(10) Pub. No.: US 2025/0263568 A1
(43) Pub. Date: Aug. 21, 2025

(54) Ink Jet Recording Method And Recording Apparatus

(71) Applicant: SEIKO EPSON CORPORATION, Tokyo (JP)

(72) Inventor: Sena GOZU, Shiojiri (JP)

(21) Appl. No.: 19/056,903

(22) Filed: Feb. 19, 2025

(30) Foreign Application Priority Data
Feb. 20, 2024 (JP) 2024-023609

(51) Int. Cl. C09D 11/322; B41J 2/155; B41M 5/52; C09D 11/037; C09D 11/38

(52) U.S. Cl. CPC C09D 11/322; B41J 2/155; B41M 5/52; C09D 11/037; C09D 11/38

(57) ABSTRACT

An ink jet recording method includes transporting a recording medium by a transport unit and ejecting an ink composition from an ink jet head to cause the ink composition to adhere to the recording medium that is being transported. The ink jet head is a line head having a length of a recording area of the recording medium or more in a direction crossing a direction of the transporting. The recording medium is an absorbent recording medium. The ink composition is a red-based aqueous ink containing a pigment. The pigment contains an azo-based pigment. A viscosity η1 of a mixed liquid when 10 parts by mass of the ink composition and 1 part by mass of an aqueous calcium propionate solution with a concentration of a Ca element of 0.3 mol/L are mixed together is less than 2.0 times a viscosity η0 of the ink composition.

The present application is based on, and claims priority from JP Application Serial Number 2024-023609, filed Feb. 20, 2024, the disclosure of which is hereby incorporated by reference herein in its entirety.

### BACKGROUND

### 1. Technical Field

The present disclosure relates to an ink jet recording method and a recording apparatus.

### 2. Related Art

The ink jet recording method enables high-definition image recording by a relatively simple apparatus and has been rapidly developed in many fields. In this development, various studies on clogging recoverability and the like have been conducted. For example, JP-A-2020-006556 discloses an ink composition containing a predetermined amine compound for the purpose of reducing nozzle missing and clogging.

### SUMMARY

When high-speed recording is performed on an absorbent recording medium using a recording apparatus having a line head, there have been problems in that color developing properties are poor or ejection stability and clogging recoverability are poor.

An ink jet recording method of the present disclosure includes transporting a recording medium by a transport unit and ejecting an ink composition from an ink jet head to cause the ink composition to adhere to the recording medium that is being transported by the transport unit. The ink jet head is a line head having a length of a recording area of the recording medium or more in a direction crossing a direction of the transporting. The recording medium is an absorbent recording medium. The ink composition is a red-based aqueous ink containing a pigment. The pigment contains an azo-based pigment. A viscosity η1 of a mixed liquid when 10 parts by mass of the ink composition and 1 part by mass of an aqueous calcium propionate solution with a concentration of a Ca element of 0.3 mol/L are mixed together is less than 2.0 times a viscosity η0 of the ink composition.

A recording apparatus of the present disclosure is an ink jet recording apparatus for obtaining a recorded product by the ink jet recording method described above and includes the ink composition, the ink jet head, and the transport unit.

### BRIEF DESCRIPTION OF THE DRAWINGS

FIG. 1 is Table 1 listing the compositions of ink compositions for use in examples and their evaluation results.

FIG. 2 is Table 2 listing the compositions of ink compositions for use in the examples and their evaluation results.

FIG. 3 is Table 3 listing the compositions of ink compositions for use in comparative examples and their evaluation results.

FIG. 4 is a diagram of an example of an ink supply mechanism of a recording apparatus for use in a recording method of the present embodiment.

FIG. 5 is a diagram of an example of the recording apparatus for use in the recording method of the present embodiment.

### DESCRIPTION OF EMBODIMENTS

An embodiment of the present disclosure (hereinafter referred to as the “present embodiment”) will be described in detail with reference to the drawings as needed, but the present disclosure is not limited to this embodiment and can be modified in various ways without departing from the gist thereof. In the drawings, the same components are denoted by the same symbols, with duplicate descriptions omitted. Positional relations such as up, down, left, and right are assumed to be based on the positional relations illustrated in the drawings unless otherwise specially noted. Furthermore, the dimensional ratios in the drawings are not limited to the illustrated ratios.

### 1. Ink Jet Recording Method

The ink jet recording method according to the present embodiment (hereinafter also referred to simply as the “present recording method”) includes transporting a recording medium by a transport unit and ejecting an ink composition from an ink jet head to cause the ink composition to adhere to the recording medium that is being transported. The ink jet head is a line head having a length of a recording area of the recording medium or more in a direction crossing a direction of the transporting. The recording medium is an absorbent recording medium. The ink composition is a red-based aqueous ink containing a pigment. The pigment contains an azo-based pigment. A viscosity η1 of a mixed liquid when 10 parts by mass of the ink composition and 1 part by mass of an aqueous calcium propionate solution with a concentration of a Ca element of 0.3 mol/L are mixed together is less than 2.0 times a viscosity η0 of the ink composition.

In absorbent recording media such as plain paper, the recording media may contain a calcium salt component. For example, at least the surface of a recording medium contains a calcium salt component, or the recording medium has a layer containing a calcium salt component. As to the layer containing a calcium salt component, for example, the recording medium may be coated with a layer containing a calcium salt component.

Such a recording medium tends to have high color developing properties of ink due to the calcium salt component contained in the recording medium. For example, it is considered that a pigment contained in the ink adhering to the recording medium reacts with a calcium salt, the pigment flocculates to become less likely to penetrate the recording medium, thus increasing color developing properties.

When printing is performed at high speed using a printer of the line system, much paper dust containing a calcium salt derived from the recording medium occurs in a recording apparatus. There is a problem in that the dust adhering to a nozzle reacts with the ink to increase its viscosity or the ink flocculates and further dries to solidify in the nozzle, thus leading to inability in recovery from clogging even when nozzle cleaning is performed. It has been revealed that such a problem is likely to occur when printing is performed continuously for a long time by the line printer. Thus, demanded is an ink composition that, even when mixed with a calcium salt, has low reactivity and can inhibit an increase in the viscosity.

In addition, in the line printer, since the recording medium is transported at high speed, there is a tendency that a recording medium transport error occurs, and the recording medium is likely to come into contact with the nozzle. Also in this case, the ink flocculates and further dries to solidify in the nozzle, causing a similar problem.

Meanwhile, when the reactivity with the calcium salt is inhibited, when the ink lands on the recording medium, the ink is likely to penetrate the inside of the recording medium, thus giving poor color developing properties. Against this, although it is considered that the concentration of the pigment is increased to improve color developing properties, there are further concerns for increasing the viscosity and reducing the ejection stability of the ink. In particular, when high-speed printing is performed by the line printer, an amount of the ink supplied to the line head is large, and thus if the ink viscosity is high, ink supply properties to the line head decrease, and the supply is not enough, which may cause a reduction in ejection stability. Thus, the pigment concentration in the ink cannot be increased very much.

In contrast, the recording method of the present embodiment uses an ink composition containing a red-based azo-based pigment as a pigment that inhibits the reactivity with the calcium salt and has excellent color developing properties. By using such a pigment, color developing properties can be maintained while reducing the reactivity of the ink composition with the calcium salt to reduce clogging. This can provide an ink jet recording method having excellent color developing properties, ejection stability, and clogging recoverability.

The following describes the details of an ink composition for use in a step included in the present recording method.

The present recording method includes transporting a recording medium by a transport unit and ejecting an ink composition from an ink jet head to cause the ink composition to adhere to the recording medium that is being transported. The ink jet head is a line head having a length of a recording area of the recording medium or more in a direction crossing a direction of the transporting.

In the line system using a line head, the head is fixed, a recording medium is moved along a sub-scanning direction (the longitudinal direction of the recording medium or a transport direction), ink droplets are ejected from a nozzle opening of the head in conjunction with this movement, and thereby images can be recorded on the recording medium. In the recording method of the line system having the line head, the head is (almost) not moved and fixed to perform recording on one pass (single pass) and thus the recording method of the line system is suitable for a case in which massive, high-speed printing is performed. Meanwhile, the transport speed of the recording medium is high, many recording media are transported, thus causing a large amount of paper dust generated, many recording medium transport errors, and the like, and thus the present embodiment is particularly useful.

The line head includes a cavity from which a housed ink composition is ejected through a nozzle, an ejection drive section provided for each cavity and imparting ejection driving force to the ink, and the nozzle provided for each cavity and ejecting the ink composition outside the head. A plurality of cavities and a plurality of ejection drive sections and nozzles provided for the respective cavities may be provided in one head independently from each other. The ejection drive section can be formed by using an electromechanical conversion element such as a piezoelectric element that changes the volume of the cavity through mechanical deformation or an electrothermal conversion element that generates heat to generate bubbles in ink and cause the ink to be ejected.

### 2. Ink Composition

In the present recording method, the ink composition is a red-based aqueous ink containing a pigment. The pigment contains an azo-based pigment. A viscosity η1 of a mixed liquid when 10 parts by mass of the ink composition and 1 part by mass of an aqueous calcium propionate solution with a concentration of a Ca element of 0.3 mol/L are mixed together is less than 2.0 times a viscosity η0 of the ink composition.

With this configuration, for example, even in a situation in which paper dust is likely to be accumulated in the nozzle due to high-speed, long-time printing by the line printer, the reactivity of the ink composition with the calcium salt can be reduced to reduce clogging and maintain color developing properties.

The viscosity η1 is preferably 1.7 times or less, and more preferably 1.5 times or less the viscosity η0. When the ratio of η1/η0 indicating the change rate of the viscosity is within the above range, the present disclosure provides excellent clogging recoverability, color developing properties, and ejection stability.

The lower limit of the viscosity change, which is not limited, is preferably 1 time or more, and more preferably 1.3 times or more.

Note that η1 and η0 are values obtained by performing the above mixing, stirring, and after being left to stand at 60° C. for 24 hours. The measured viscosity is a value when viscosity at 25° C. is measured. When the viscosity measurement is performed, a sample which is obtained by stirring the mixed liquid and in which the component does not become unbalanced is used. As to calcium propionate, for example, a pentahydrate may be used.

The value of the viscosity η1 to the viscosity η0 may be adjusted by adjusting the type of the pigment or the content of the pigment.

### 2.1. Pigment

The ink composition contains an azo-based pigment as a pigment. By containing the azo-based pigment, excellent color developing properties can be obtained even when the reactivity of the ink with the calcium salt is inhibited.

The ink may contain other pigments in addition to the azo-based pigment.

Examples of the other pigments include quinacridone-based pigments, quinacridonequinone-based pigments, dioxazine-based pigments, phthalocyanine-based pigments, anthrapyridine-based pigments, anthanthrone-based pigments, indanthrone-based pigments, flavanthrone-based pigments, perylene-based pigments, diketopyrrolopyrrole-based pigments, perinone-based pigments, quinophthalone-based pigments, anthraquinone-based pigments, thioindigo-based pigments, benzimidazolone-based pigments, isoindolinone-based pigments, and azomethine-based pigments.

### 2.1.1. Azo-Based Pigment

The ink composition of the present embodiment contains the azo-based pigment. Examples of the azo-based pigment include monoazo pigments, disazo pigments, condensed disazo pigments, and benzimidazolone pigments. Among the azo-based pigments, a pigment that can develop a red-based color is used.

The ink composition of the present embodiment is a red-based ink. The red-based ink is an ink mainly used to represent red when printing reproducing secondary or more colors is performed using a plurality of colors of inks. For example, the red-based ink is a magenta ink, a red ink, or an ink similar to these inks.

The red-based ink is preferably the magenta ink. The magenta ink means an ink that is normally used as an ink set together with a cyan ink, a yellow ink, and, as needed, a black ink. Examples of the magenta ink include inks generally named the magenta ink and the whole of inks recalling being the magenta ink in commercially available ink cartridges.

The red refers to a color with a hue angle being within a predetermined range in the L*a*b* color coordinate system standardized by International Commission on Illumination (CIE). The hue angle of the red is preferably 5° or more and 60° or less, 15° or more and 50° or less, or 25° or more and 40° or less. The red-based ink is an ink mainly used when the red is printed. The red-based ink is preferably an ink that can represent the red by itself.

The recording method of the present embodiment may be performed further using a cyan ink, a yellow ink, and, as needed, a black ink.

The red-based ink is used for recording red images, and the red images are required to be images having particularly high visibility. There are many types of pigments for use in the red-based ink. Thus, for the red-based ink, the present embodiment is particularly useful.

As to the azo-based pigment, an azo-based pigment, the pigment capable of establishing an ink jet ink composition as a red-based ink can be used. Examples of the azo-based ink include azo-based inks, the inks given numbers of C.I. Pigment Red.

Specific examples of such an azo-based pigment include C.I.Pigment Red 5, C.I.Pigment Red 17, C.I.Pigment Red 22, C.I.Pigment Red 31, C.I.Pigment Red 48:1, C.I.Pigment Red 48:2, C.I.Pigment Red 53:1, C.I.Pigment Red 57:1, C.I.Pigment Red 146, C.I.Pigment Red 150, C.I.Pigment Red 185, C.I.Pigment Red 114, C.I.Pigment Red 146, C.I.Pigment Red 150, C.I.Pigment Red 170, C.I.Pigment Red 184, C.I.Pigment Red 185, C.I.Pigment Red 208, C.I.Pigment Red 245, C.I.Pigment Red 268, C.I.Pigment Red 269, and solid solutions of these.

The ink composition preferably contains one or more selected from the group consisting of C.I.Pigment Red 150, C.I.Pigment Red 269, and C.I.Pigment Red 17 as the azo-based pigment. There is a tendency that using the above compounds as the azo-based pigment further improves the effect of clogging recoverability, color developing properties, and ejection stability by the present disclosure.

From the viewpoint of obtaining images with even better color developing properties, the azo-based pigment is preferably a compound represented by Formula (I) below and a solid solution thereof. Note that in Formula (I), A represents a hydrogen atom or an aromatic group.

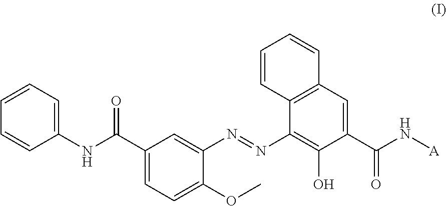

The aromatic group is a group having an aromatic ring such as a benzene ring or a naphthalene ring, and the aromatic ring can be substituted or unsubstituted. The aromatic ring directly bonds to a nitrogen atom to which the aromatic group bonds. When the aromatic ring has a substituent, the substituent is not particularly limited, which is, for example, an organic group or an inorganic group. The number of substituents can be any selected number. The substituent is not limited, and examples thereof include an alkyl group, a halo group, an alkoxy group, a hydroxy group, a carboxy group, an amino group, and a nitro group.

The azo-based pigment may be a resin-dispersed pigment dispersed with a resin or a self-dispersed pigment in which the surface of the pigment is treated to introduce functional groups. The resin-dispersed pigment is preferred.

The volume average particle size D50 of the azo-based pigment is preferably 110 nm or less. The volume average particle size D50 of the azo-based pigment can be measured using a particle size distribution measurement apparatus. Examples of the particle size distribution measurement apparatus include a particle size distribution meter with dynamic light scattering as its measurement principle (for example, “Nanotrac Series” manufactured by MicrotracBEL Corporation). The volume average particle size is a D50 value. The volume average particle size is preferably 10 nm or more and 110 nm or less, more preferably 50 nm or more and 110 nm or less, and even more preferably 80 nm or more and 110 nm or less.

The content of the solid content of the azo-based pigments is preferably 0.3% by mass or more and 10% by mass or less, preferably 1 to 9% by mass, more preferably 2 to 8% by mass, even more preferably 3 to 7% by mass, and particularly preferably 4 to 6% by mass with respect to the total amount of the ink composition. The content is also preferably 5% by mass or more.

This content tends to further improve the effect of clogging recoverability, color developing properties, and ejection stability,

The content of the solid content of the azo-based pigments is preferably 15% by mass or more and 100% by mass or less, 25% by mass or more and 100% by mass or less, 45% by mass or more and 100% by mass or less, 65% by mass or more and 100% by mass or less, or 85% by mass or more and 100% by mass or less with respect to the total amount of the pigment.

Meanwhile, the content of the solid content of the azo-based pigments is also preferably 90% by mass or less, and preferably 70% by mass or less, more preferably 50% by mass or less, and even more preferably 30% by mass or less with respect to the total amount of the pigment.

These contents tend to further improve the effect of clogging recoverability, color developing properties, and ejection stability.

The ink composition of the present embodiment is preferably a magenta ink. The recording method of the present disclosure is particularly effective when the magenta ink is used.

The ink composition preferably further contains a quinacridone-based pigment as the other pigment. When further containing the quinacridone-based pigment, the ink composition has even better lightfastness and can be ready for outdoor use of recorded products. Examples of the quinacridone-based pigment include C.I.Pigment Violet 19 and C.I.Pigment Red 122, and C.I.Pigment Violet 19 is preferred.

When the other pigments are contained, the content of the solid content of the other pigments is preferably 0.1% by mass or more and 1.6% by mass or less, 0.2% by mass or more and 1.2% by mass or less, or 0.3% by mass or more and 1.0% by mass or less with respect to the total amount of the ink composition. This content tends to further improve lightfastness.

When the other pigments are contained, the content of the solid content of the other pigments is preferably 1% by mass or more and 85% by mass or less, 1% by mass or more and 65% by mass or less, 1% by mass or more and 45% by mass or less, or 1% by mass or more and 25% by mass or less with respect to the total amount of the pigment. This content tends to further improve lightfastness.

The content of the quinacridone-based pigment among the other pigments may be in the above range, which is preferred.

The total content of the solid content of the pigment is preferably 0.3% by mass or more and 10% by mass or less, 0.5% by mass or more and 10% by mass or less, 0.6% by mass or more and 9% by mass or less, 0.7% by mass or more and 8% by mass or less, or 0.8% by mass or more and 7% by mass or less with respect to the total mass of the ink composition. Furthermore, the total content is more preferably 2 to 8% by mass, even more preferably 3 to 7% by mass, and particularly preferably 4 to 6% by mass, which is also preferably 5% by mass or more.

There is a tendency that the content of the pigment being within the above range provides even better color developing properties, ejection stability, and clogging recoverability.

The ink composition may contain a resin dispersant dispersing the pigment. Preferred examples of the resin dispersant include resin dispersants adsorbing resin to the surface of the pigment and dispersing the pigment. Examples of such resin dispersants include anionic resins. The acid value of the resin dispersant is, for example, 300 mgKOH/g or less, preferably 250 mgKOH/g or less, more preferably 200 mgKOH/g or less, even more preferably 180 mgKOH/g or less, and particularly preferably 150 mgKOH/g or less. There is a tendency that the acid value of the resin dispersant being within the above range reduces the reactivity of the ink with the calcium salt and further improves the effect of clogging recoverability and ejection stability.

On the other hand, the lower limit of the acid value of the resin dispersant is preferably 30 mgKOH/g or more, more preferably 50 mgKOH/g or more, even more preferably 100 mgKOH/g or more, and still even more preferably 150 mgKOH/g or more. The acid value of the resin dispersant being within the above range provides even better color developing properties. In addition, being in the above range or more is preferred in that excellent inhibition of the phase separation of an acetylene glycol-based surfactant, which will be described below, is achieved.

The acid value of the resin dispersant can be adjusted by, for example, the ratio of the amount of a monomer having an acidic group charged when used for the synthesis of the resin or the like. Examples of the acidic group include a carboxy group.

As the resin of the resin dispersant, for example, acrylic-based resins, urethane-based resins, maleic acid-based resins, or the like can be used. Acrylic-based resins and maleic acid-based resins are preferred.

When the resin dispersant is used, the mass ratio of the amount of the resin dispersant used to the amount of the pigment used (the resin dispersant/the pigment) is preferably 1 or more and 20 or less, 2 or more and 10 or less, or 3 or more and 8 or less. There is a tendency that the mass ratio of the amount of the resin dispersant used to the amount of the pigment used being within the above range further improves the effect of clogging recoverability, color developing properties, and ejection stability by the present disclosure.

The pigment may be a self-dispersed pigment. The self-dispersed pigment is a pigment obtained by introducing hydrophilic functional groups to the surface of the pigment using a chemical reaction to impart dispersion stability to the pigment and to disperse the pigment. Examples of the hydrophilic functional groups include acidic groups such as a carboxy group, a phosphorus-containing group such as a phosphoric acid group, and a sulfo group.

When the pigment is the self-dispersed pigment, the number of the hydrophilic functional groups to be introduced to the surface of the pigment may be adjusted to adjust the thickening ratio of the ink. Note that even when the thickening ratio of the ink is less than two times, the resin-dispersed pigment is preferred in that the dispersion stability of the pigment is easily obtained.

### 2.2. Surfactant

The ink composition may contain a surfactant. Examples of the surfactant include acetylene glycol-based surfactants, silicone-based surfactants, and fluorine-based surfactants. Among these, the ink composition preferably contains the acetylene glycol-based surfactant. There is a tendency that containing the acetylene glycol-based surfactant reduces the surface tension of the ink, improves wettability against the recording medium, and further improves clogging recoverability and ejection stability. As the surfactant, one may be used alone, or two or more may be used in combination.

From the viewpoint of further improving the effect by the present disclosure, the ink composition preferably contains an acetylene glycol-based surfactant with an HLB value of 5 or less.

In this case, the acetylene glycol-based surfactant with an HLB value of 5 or less is relatively even better than one with an HLB value of greater than 5 in the above points, but tends to have low solubility to water and is likely to undergo phase separation in the ink to have reduced ejection stability and the like.

The lower limit of the HLB value is 0 or more and is preferably 1 or more. Furthermore, both the acetylene glycol-based surfactant with an HLB value of 5 or less and one with an HLB value of greater than 5 are preferably contained, both one with an HLB value of 5 or less and one with an HLB value of 7 or more are more preferably contained, and both one with an HLB value of 5 or less and one with an HLB value of 10 or more are even more preferably contained. In this case, even better wettability, clogging recoverability, ejection stability, and the like are achieved, and inhibition of phase separation is even better, which is preferred. The upper limit of the HLB value is 20 or less and is preferably 15 or less.

In the present specification, the “hydrophilic lipophilic balance (HLB value)” is a value calculated by the Griffin method. Specifically, the HLB value of the surfactant can be calculated in accordance with Expression (H) below:

HLB value=20×(% by mass of hydrophilic group) (H)

Examples of commercially available products of the acetylene glycol-based surfactant include Surfynol 104PG50 (HLB value=4), Surfynol 104, Surfynol 420 Surfynol 82, Surfynol DF110D, Surfynol 104S, Surfynol 420, Surfynol 82, and Surfynol MD-20 (product names, manufactured by Nissin Chemical Co., Ltd.); and Olfine E1010 (a product name, HLB value: 13 to 14, manufactured by Air Products, Inc.). From the viewpoint of producing the effect by the present disclosure more effectively and surely, the ink composition preferably contains at least either Surfynol 104PG50 or Olfine E1010 and more preferably contains Surfynol 104PG50 and Olfine E1010.

The content of the surfactant is preferably 0.05% by mass or more and 5.0% by mass or less, 0.1% by mass or more and 3.0% by mass or less, or 0.2% by mass or more and 2.0% by mass or less with respect to the total amount of the ink composition. There is a tendency that the content of the surfactant being within the above range further improves clogging recoverability, color developing properties, and ejection stability. From the same viewpoint, the content of the acetylene glycol-based surfactant is preferably 0.05% by mass or more and 5.0% by mass or less, 0.1% by mass or more and 3.0% by mass or less, or 0.2% by mass or more and 2.0% by mass or less with respect to the total amount of the ink composition. Furthermore, the content is preferably 0.5 to 1.0% by mass.

The content of the acetylene glycol-based surfactant with an HLB value of 5 or less may be within the above range, which is preferred in view of the above point. Furthermore, the content is preferably 0.2% by mass or more and 0.8% by mass or less, more preferably 0.3% by mass or more and 0.7% by mass or less, and even more preferably 0.4% by mass or more and 0.6% by mass or less.

### 2.3. Lactam-Based Compound

The ink composition preferably contains a lactam-based compound. The lactam-based compound has a structure in which a carboxy group and an amino group in the molecule form a ring by a dehydration condensation reaction. There is a tendency that containing the lactam-based compound further improves the miscibility of the surfactant, especially the acetylene glycol-based surfactant to the ink composition. From the same viewpoint, the lactam-based compound is preferably a lactam-based compound having a four- to eight-membered lactam ring, more preferably one having a five- to eight-membered lactam ring, and even more preferably has a six- to eight-membered lactam ring. The lactam-based compound is also preferably one having a four- to five-membered lactam ring.

As the lactam-based compound, one may be used alone, or two or more may be used in combination. Also, lactams having a four- to-five-membered lactam ring and lactams having a six- to eight-membered lactam ring are preferably used in combination.

Specific examples of the lactam-based compound include ε-caprolactam, N-hydroxyethyl pyrrolidone (HEP), δ-valerolactam, and 5-(methylamino)pentanoic acid lactam. ε-Caprolactam, N-hydroxyethyl pyrrolidone (HEP), 2-pyrrolidone, and the like are preferably contained. There is a tendency that containing these compounds further improves clogging recoverability, color developing properties, and ejection stability.

The content of the lactam-based compound is preferably 0.1% by mass or more and 15% by mass or less, or 0.5% by mass or more and 10% by mass or less with respect to the total mass of the ink composition. Furthermore, the content is preferably 1 to 8% by mass, and more preferably 2 to 7% by mass.

The content of lactams having a six- to eight-membered lactam ring may be within the above range, which is preferably 1 to 5% by mass, and more preferably 2 to 4% by mass.

There is a tendency that the content of the lactam-based compound being within the above range further improves clogging recoverability, color developing properties, and ejection stability.

### 2.4. Water-Soluble Organic Solvent

The ink composition preferably contains a water-soluble organic solvent as a solvent component. There is a tendency that containing the water-soluble organic solvent provides excellent clogging recoverability and ejection stability. Examples of the water-soluble organic solvent include polyhydric alcohols, glycol ethers, nitrogen-containing solvents, esters, and cyclic esters. Among these, polyhydric alcohols are preferably contained as the water-soluble organic solvent.

The polyhydric alcohols have two or more hydroxy group in the molecule. Examples thereof include alkanediols such as 1,2-hexanediol and 1,2-butanediol and polyols.

Examples of specific compounds of alkanediols include 1,2-hexanediol, 1,2-pentanediol, 1,2-octanediol, 1,6-hexanediol, 2-methyl-2,4-pentanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, and 2-methylpentane-2,4-diol. Among these, from the viewpoint of further improving clogging recoverability and ejection stability, 1,2-hexanediol is preferably contained. Alkanediols having five or more carbon atoms are preferred, and alkanediols having five to eight carbon atoms are more preferred. 1,2-Alkanediols are preferred.

Examples of specific compounds of polyols include ethylene glycol, propylene glycol, 1,2-propanediol, 1,2-butanediol, 1,3-propanediol, 1,4-butanediol, diethylene glycol, triethylene glycol, dipropylene glycol, trimethylol propane, and glycerin.

Examples thereof include polyols having three or more hydroxide groups in the molecule, ones having an ether group in their skeleton (intermolecular condensates of alkanediols), and alkanediols having four or less carbon atoms.

Glycol ethers are obtained by etherifying one hydroxy group of the above polyhydric alcohols. The etherification is preferably alkyl etherification. Examples thereof include diethers and monoethers, and monoethers are preferred. Examples thereof, but are not limited to, triethylene glycol monobutyl ether.

Among these, from the viewpoint of further improving clogging recoverability and ejection stability, glycerin, triethylene glycol, or triethylene glycol monobutyl ether is preferably used.

The content of the water-soluble organic solvent is preferably 5.0% by mass or more and 40% by mass or less, 10% by mass or more and 30% by mass or less, or 12% by mass or more and 25% by mass or less with respect to the total amount of the ink composition. Furthermore, the content is preferably 15 to 20% by mass.

There is a tendency that the content of the water-soluble organic solvent being within the above range produces the effect by the present disclosure more effectively and surely.

The content of alkanediols is preferably 0.5% by mass or more and 7.0% by mass or less, or 1.0% by mass or more and 5.0% by mass or less with respect to the total amount of the ink composition. There is a tendency that being within such a range produces the effect by the present disclosure more effectively and surely.

The content of alkanediols having five or more carbon atoms may be within the above range, which is preferred.

The content of polyols is preferably 5.0% by mass or more and 30% by mass or less, or 10% by mass or more and 20% by mass or less with respect to the total amount of the ink composition. There is a tendency that being within such a range produces the effect by the present disclosure more effectively and surely.

The content of a polyol having a normal boiling point of 280° C. or higher in the ink is preferably 1 to 15% by mass, more preferably 3 to 10% by mass, and even more preferably 5 to 9% by mass.

The content of polyhydric alcohols including the polyol having a normal boiling point of 280° C. or higher in the ink may be within the above range.

### 2.5. Resin Particles

The ink composition may contain resin particles. Examples of the resin particles include resin particles containing urethane-based resins, acrylic-based resins, fluorene-based resins, polyolefin-based resins, rosin modified resins, terpene-based resins, polyester-based resins, polyamide-based resins, epoxy-based resins, polyvinyl chloride-based resins, or the like. Among these, from the viewpoint of producing the effect by the present disclosure more effectively and surely, urethane-based resins are preferred. These resin particles are often handled in emulsion form but may be powdery. As the resin particles, one may be used alone, or two or more may be used in combination.

Examples of the urethane-based resins include urethane resin emulsions. The urethane resin emulsions are not particularly limited so long as they are resin emulsions having a urethane bond in the molecule. Examples thereof include polyether type urethane resins containing an ether bond in the main chain, polyester type urethane resins containing an ester bond in the main chain, and polycarbonate type urethane resins containing a carbonate bond in the main chain. Among these, cationic or anionic urethane resin fine particles are preferred.

Examples of commercially available products of the urethane-based resin particles include Superflex 420, 600, 610, and 620 (product names, manufactured by DKS Co. Ltd.), Hydran CP-7010, CP-7020, and CP-7030 (product names, manufactured by Dainippon Ink and Chemicals, Inc.), and Urethane Emulsion WBR-2120C and WBR-2122C (product names, manufactured by Taisei Fine Chemical Co., Ltd.). Among these, from the viewpoint of producing the effect by the present disclosure more effectively and surely, Superflex 420 is preferred.

Examples of the acrylic-based resin particles include acrylic resin emulsions. The acrylic resin emulsions are not particularly limited, and examples thereof include acrylic resin particles obtained by polymerizing a (meth)acrylic monomer such as (meth)acrylic acid or (meth)acrylate and ones obtained by copolymerizing a (meth)acrylic monomer and other monomers.

The content of the resin particles is 0.05% by mass or more and 3.0% by mass or less, 0.1% by mass or more and 2.0% by mass or less, or 0.2% by mass or more and 1.0% by mass or less with respect to the total amount of the ink composition. The content of the resin particles being within the above range can produce the effect by the present disclosure more effectively and surely.

### 2.6. Water

The ink of the present embodiment is an aqueous ink. The aqueous ink is an ink containing water as a solvent component that the ink contains.

The water is preferably one with ionic impurities excluded to the utmost. Such water is not particularly limited, and examples thereof include pure water such as ion exchanged water, ultrafiltered water, reverse osmosis water, and distilled water and ultrapure water.

The content of the water is preferably 30% by mass or more and 99% by mass or less, more preferably 35% by mass or more and 90% by mass or less, and even more preferably 40% by mass or more and 80% by mass or less with respect to the total amount of the ink composition.

### 2.7. Other Components

The ink composition of the present embodiment may contain components other than those described above as needed. Examples of such components include pH regulators, chelating agents, and anticorrosives.

Examples of the pH regulators include inorganic acids (such as sulfuring acid, hydrochloric acid, and nitric acid), inorganic bases (such as lithium hydroxide, sodium hydroxide, potassium hydroxide, and ammonia), organic bases (such as triethanolamine, diethanolamine, monoethanolamine, and tripropanolamine), and organic acids (such as adipic acid, citric acid, and succinic acid). From the viewpoint of producing the effect by the present disclosure more effectively and surely, triethanolamine is preferred.

The content of the pH regulators is preferably 0.05% by mass or more and 3.0% by mass or less, 0.1% by mass or more and 2.0% by mass or less, or 0.2% by mass or more and 1.0% by mass or less with respect to the total amount of the ink composition. There is a tendency that the content of the pH regulators being within the above range produces the effect by the present disclosure more effectively and surely.

### 3. Recording Medium

The present embodiment uses an absorbent recording medium as a recording medium. The absorbent recording medium is a recording medium of which a recording face includes paper such as plain paper or paper for exclusive use for ink jet, cloth, an organic material or an inorganic material having properties to absorb ink, or the like. Paper such as plain paper or paper for exclusive use for ink jet is preferred.

From the viewpoint of producing the effect by the present disclosure more effective and surely, at least part of the recording medium to absorb the ink composition preferably contains a calcium salt. The part is, for example, the entire recording medium or a layer to absorb the ink composition.

Examples of the calcium salt include water-soluble calcium salts and water-insoluble calcium salts. In view of improving the color developing properties of the ink, the water-soluble calcium salts are preferred, but the water-insoluble calcium salts may also be used. Examples of the water-insoluble calcium salts include calcium carbonate. Examples of the water-soluble calcium salts include calcium chloride.

In the present embodiment, the “absorbent recording medium” refers to a recording medium in which its water absorption amount from the start of contact to 30 msec in the Bristow method is greater than 10 mL/m². This Bristow method is the most popular method as a method for measuring a liquid absorption amount in a short time and is employed also by Japan Technical Association of the Pulp and Paper Industry (JAPAN TAPPI). The details of the test method are described in Standard No. 51 “Paper and Paperboard—Liquid Absorbency Test Method—Bristow Method” of “Japan TAPPI Paper Pulp Test Methods 2000 Ed.”

The recording speed of the present recording method is preferably 35 pages/minute (ppm) or more, more preferably 40 pages/minute or more, and even more preferably 50 pages/minute (ppm) or more in terms of the transport speed of the recording medium. The recording speed is particularly preferably 60 ppm or more. When recording is performed at such a speed, clogging is likely to occur, and the effect by the present disclosure is more effective. The above pages are preferably based on an A4 sheet.

The upper limit of the recording speed, which is not limited, is preferably 100 pages/minute or less, and more preferably 80 pages/minute or less. Pages/minute is pages/minute=sheets/minute when single-sided printing is performed on the recording medium. Pages/minute is pages/minute=sheets/minute×2 when double-sided printing is performed on the recording medium.

When the recording speed is in the above range or more, recording is performed fast, which is useful, but the occurrence of paper dust and the amount of ink supplied tend to increase, in which the effect by the present disclosure is more effective.

When double-sided printing is performed, the occurrence of paper dust and the amount of ink supplied tend to increase, in which the effect by the present disclosure is more effective.

The recording medium is preferably an A4-sized recording medium, but the size of the recording medium is not limited. This is because paper feed from a paper feed tray and paper discharge to a paper discharge tray of the recording medium are performed once in one sheet of recording, and there arises a possibility of the occurrence of paper dust and the like.

### 4. Ink Jet Recording Apparatus

The ink jet recording apparatus of the present embodiment is for obtaining a recorded product by the ink jet recording method described above and includes the ink composition described above, the ink jet head described above, and the transport unit described above.

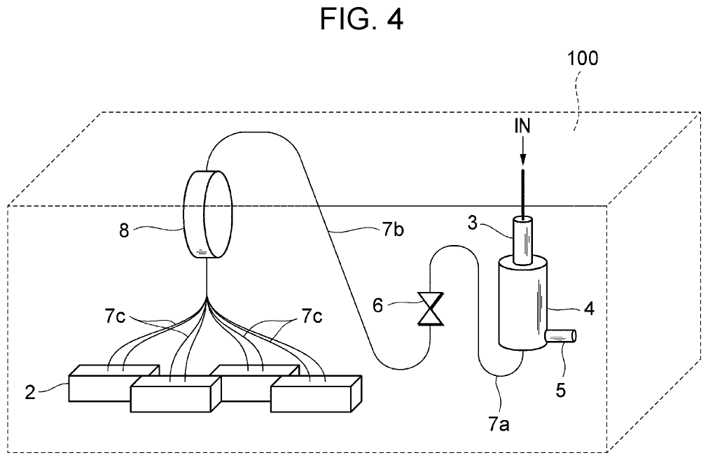

FIG. 4 illustrates an aspect of an ink supply mechanism of the ink jet recording apparatus. More specifically, FIG. 4 is a schematic perspective view of the arrangement of an ink container and a pressure regulating valve in the ink supply mechanism. As illustrated in FIG. 4, for example, an ink container 4 and a pressure regulating valve 8 are included in an ink supply mechanism 100. In addition, a transparent, tubular container 3 attached to the ink container 4 and a pressure sensor 5 are also included. For all a tube 7a connecting the ink container 4 and an opening/closing valve 6 to each other, a tube 7b connecting the opening/closing valve 6 and the pressure regulating valve 8 to each other, and a tube 7c connecting the pressure regulating valve 8 and a droplet ejection head set 2 to each other, flexible, such as polyethylene terephthalate, tubes are used. From an ink cartridge or the like, not shown, ink is supplied from IN to the container 3 of the ink container 4.

The droplet ejection head set 2 is an ink jet head in which a plurality of heads are disposed and that is a line head. In the droplet ejection head set 2, the heads are disposed side by side in the right and left direction of the drawing. Each of the heads has a nozzle row, not shown, and in the nozzle row, a plurality of nozzles are disposed side by side in the right and left direction of the drawing.

From the viewpoint of the productivity of the heads, rather than a single-row, long line head, the heads are often disposed in a combined manner as in the droplet ejection head set 2 and are used as the line head. During printing, the ink is supplied to ejection sections of the heads of the droplet ejection head set 2 by the pressure regulating valve 8, and thus a large ink flow is required in a short time. The recording method of the present embodiment is suitable for such a line system recording apparatus, which requires a large ink flow in a short time.

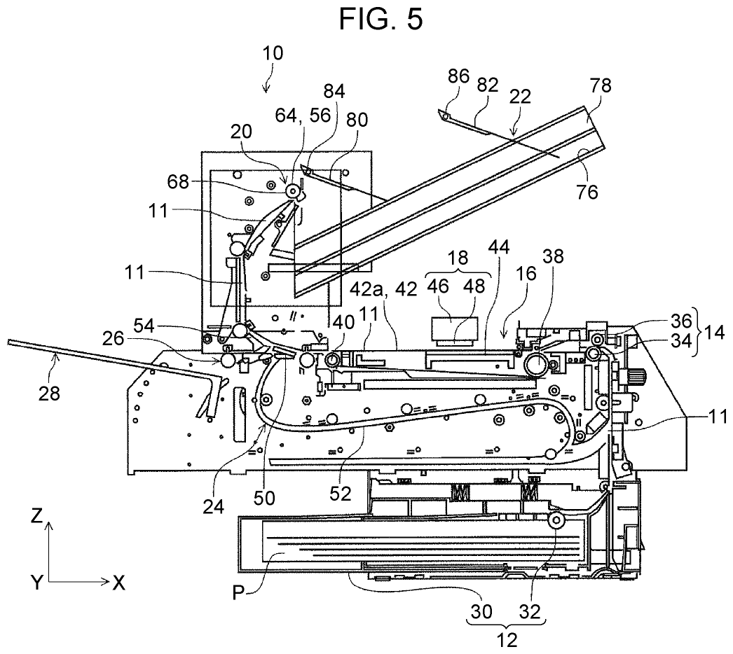

Next, FIG. 5 illustrates another aspect of the ink jet recording apparatus. FIG. 5 is an overall diagram of the ink jet recording apparatus including a configuration about the transport of the recording medium and the like.

The ink jet recording apparatus according to the present embodiment will be described in more detail with reference to FIG. 5. In the X-Y-Z coordinate system illustrated in FIG. 5, the X direction shows the length direction of the recording medium, the Y direction shows the width direction of the recording medium in a transport path in the recording apparatus, and the Z direction shows an apparatus height direction.

A recording apparatus 10 is, as an example, a line type ink jet printer that can perform high-speed, high-density printing. The recording apparatus 10 includes a feeding section 12 housing a recording medium P such as a sheet, a transport section 14, a belt transport section 16, a recording section 18, a face-down (Fd) discharge section 20 as a “discharge section,” a face-down (Fd) mounting section 22 as a “mounting section,” an inverted path section 24 as an “inverted transport mechanism,” a face-up (Fu) discharge section 26, and a face-up (Fu) mounting section 28.

The feeding section 12 is disposed at a lower part of the apparatus in the recording apparatus 10. The feeding section 12 includes a feeding tray 30 housing the recording medium P and a feeding roller 32 sending out the recording medium P housed in the feeding tray 30 to a transport path 11.

The recording medium P housed in the feeding tray 30 is fed to the transport section 14 along the transport path 11 by the feeding roller 32. The transport section 14 includes a transport drive roller 34 and a transport driven roller 36. The transport drive roller 34 is rotationally driven by a drive source, not shown. In the transport section 14, the recording medium P is nipped between the transport drive roller 34 and the transport driven roller 36 and is transported to the belt transport section 16 positioned downstream in the transport path 11.

The belt transport section 16 includes a first roller 38 positioned upstream in the transport path 11, a second roller 40 positioned downstream, an endless belt 42 mounted on the first roller 38 and the second roller 40 in a rotationally movable manner, and a support 44 supporting an upper section 42a of the endless belt 42 between the first roller 38 and the second roller 40.

The endless belt 42 is driven so as to be moved from a +X direction to a −X direction in the upper section 42a by the first roller 38 or the second roller 40 driven by a drive source, not shown. Thus, the recording medium P transported from the transport section 14 is further transported downstream in the transport path 11 in the belt transport section 16.

The recording section 18 includes a line type ink jet head 48 and a head holder 46 holding the ink jet head 48. The ink jet head 48 is disposed with the Y-axis direction in the drawing as a direction in which the nozzles of the nozzle row of the line head are arranged. For example, the droplet ejection head set 2 in FIG. 4 may be disposed with the Y-axis direction as the direction in which the nozzles of the nozzle row are arranged. Note that the ink jet recording apparatus in FIG. 5 may also have an ink supply system such as an ink container, which is omitted in the drawing.

The ink jet head 48 is a line head having a length of a recording area of the recording medium or more in a direction crossing a direction of transporting the recording medium (the Y direction in the drawing). The length of the line head is the length of the nozzle row of the line head and is the length thereof from one end to the other end in the Y direction. The length of the recording area of the recording medium is the length of the recording medium from one end to the other end in the Y direction in which recording is possible in recording.

Note that if the recording section 18 is provided with an ink jet head in a carriage reciprocating in the Y-axis direction, and one of the heads in FIG. 4 is configured as an ink jet head in which the direction in which the nozzles of the nozzle row are arranged is set to the X direction in FIG. 5, a serial type ink jet recording apparatus is made.

The ink jet head 48 is disposed so as to face the upper section 42a of the endless belt 42 supported on the support 44. When the recording medium P is transported in the upper section 42a of the endless belt 42, the ink jet head 48 ejects the ink toward the recording medium P to execute recording. The recording medium P, while being subjected to recording, is transported downstream in the transport path 11 by the belt transport section 16.

A first branch section 50 is provided downstream in the transport path 11 of the belt transport section 16. The first branch section 50 is configured to be able to switch between the transport path 11 transporting the recording medium P to the Fd discharge section 20 or the Fu discharge section 26 and an inverted path 52 of the inverted path section 24 inverting the recording face of the recording medium P and again transporting the recording medium P to the recording section 18. Note that the recording medium P transported switched to the inverted path 52 by the first branch section 50, with its recording face inverted in a transport process in the inverted path 52, is again transported to the recording section 18 such that the face opposite the original recording face faces the ink jet head 48. Thus, double-sided printing is performed. When double-sided printing is performed, the transport path is longer, and the occurrence of paper dust tends to increase, in which the recording method of the present embodiment is particularly useful.

A second branch section 54 is further provided downstream of the first branch section 50 along the transport path 11. The second branch section 54 is configured to be able to switch the transport direction of the recording medium P so as to transport the recording medium P toward the Fd discharge section 20 or to transport the recording medium P toward the Fu discharge section 26.

The recording medium P transported toward the Fd discharge section 20 in the second branch section 54 is discharged from the Fd discharge section 20 to be mounted on the Fd mounting section 22. In this process, the recording medium P is mounted such that the recording face of the recording medium P faces the Fd mounting section 22. The recording medium P transported toward the Fu discharge section 26 in the second branch section 54 is discharged from the Fu discharge section 26 to be mounted on the Fu mounting section 28. In this process, the recording medium P is mounted such that the recording face of the recording medium P is directed opposite the Fu mounting section 28.

### EXAMPLES

The present disclosure will be described below more specifically with reference to examples and comparative examples. The present disclosure is not limited by the following examples at all.

### 1. Preparation of Ink Composition

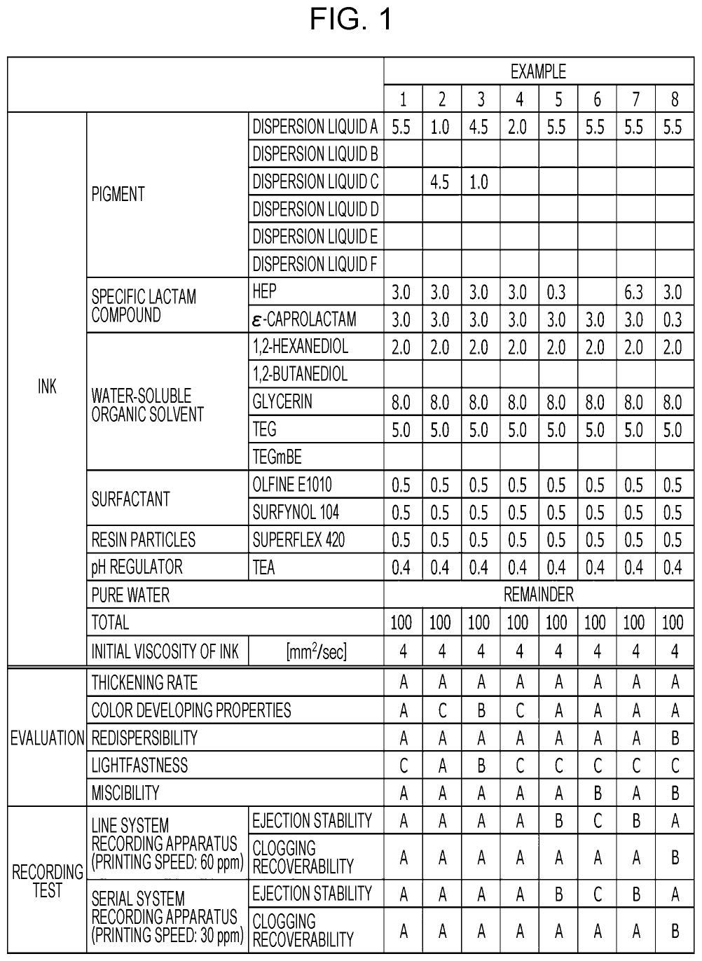

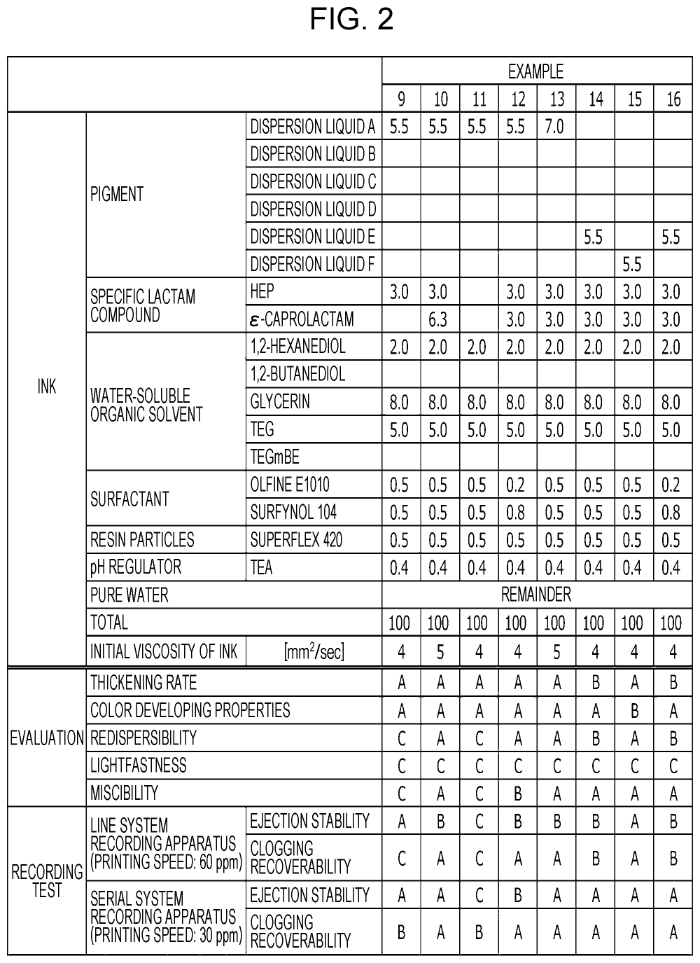

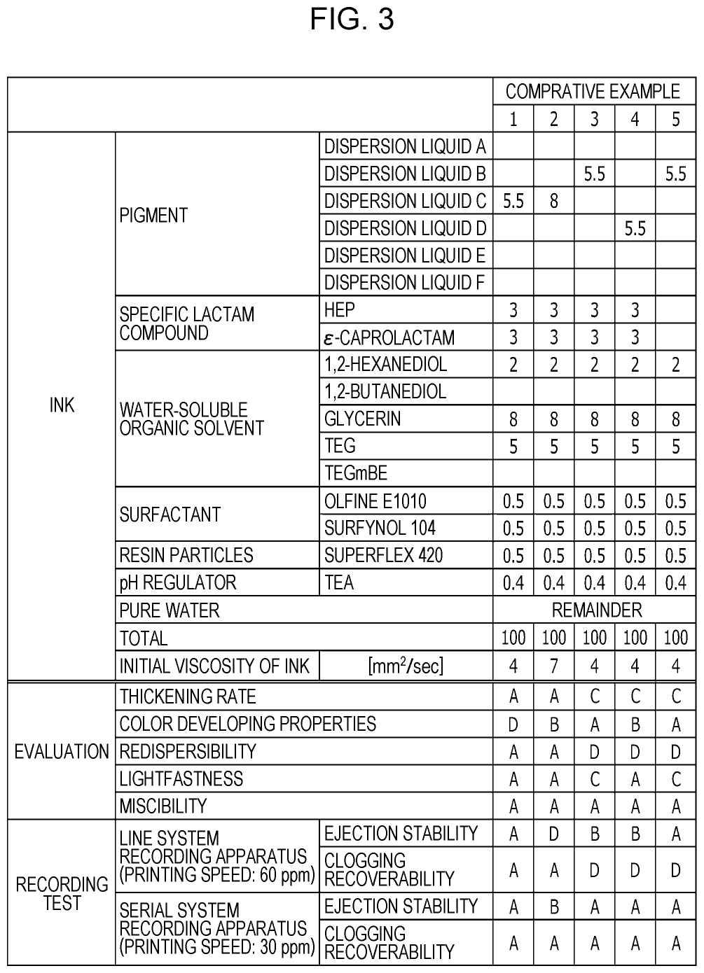

FIG. 1 to FIG. 3 describe Table 1 to Table 3 listing the compositions of ink compositions used in the examples and the comparative examples and their evaluation results.

The components were put in a tank for a mixture so as to be the compositions listed in Table 1 to Table 3, were mixed together and stirred, and were further filtered using a membrane filter to obtain an ink jet ink composition of each example. Note that the values of the components shown in the examples in the tables represent % by mass unless otherwise specially described. In the tables, the values of the inorganic oxide particles, the resin particles, and the pigment dispersion liquids represent % by mass of the solid contents of the inorganic oxide particles, the resin particles, and the pigments, respectively. All the obtained inks were magenta inks.

The details of the abbreviations and product components used in Table 1 to Table 3 are as follows. The figure described on the right of the abbreviation of the solvent indicates the SP value of the solvent.

### Pigment

The pigment dispersion liquids A to F were prepared as follows:

Dispersion liquid A: Mixed together and stirred were 20% by mass of C.I.Pigment Red 150 (PR150) as an azo pigment, 5% by mass of a resin dispersant as a sodium hydroxide neutralized product of a styrene-acrylic acid copolymer (acid value: 150 mgKOH/g, molecular weight: 10,000), and 75% by mass of pure water to obtain a mixture. This mixture was put in a wet sand mill filled with zirconia beads with a diameter of 0.3 mm to be subjected to dispersion treatment for 6 hours. Subsequently, the zirconia beads were removed using a separator, and the mixture was filtered using a cellulose acetate filter with a pore size of 3.0 μm to obtain a pigment dispersion liquid.

Dispersion liquid B: The dispersion liquid B was obtained in the same manner as for the dispersion liquid A except that the acid value of the resin dispersant was changed to 260 mgKOH/g.

Dispersion liquid C: The dispersion liquid C was obtained in the same manner as for the dispersion liquid A except that C.I.Pigment Violet 19 (PV19) as a quinacridone-based pigment was used instead of C.I.Pigment Red 150 (PR150).

Dispersion liquid D: The dispersion liquid D was obtained in the same manner as for the dispersion liquid A except that C.I.Pigment Violet 19 (PV19) as a quinacridone-based pigment was used instead of C.I.Pigment Red 150 (PR150), and the acid value of the resin dispersant was changed to 260 mgKOH/g.

Dispersion liquid E: The dispersion liquid E was obtained in the same manner as for the dispersion liquid A except that the acid value of the resin dispersant was changed to 200 mgKOH/g.

Dispersion liquid F: The dispersion liquid F was obtained in the same manner as for the dispersion liquid A except that C.I.Pigment Red 17 (PR17) as an azo pigment was used instead of C.I.Pigment Red 150 (PR150).

### Lactam Compound

HEP
ε-Caprolactam

### Water-Soluble Organic Solvent

1,2-Hexanediol
1,2-Butanediol
Glycerin
TEG (triethylene glycol)
TEGmBE (triethylene glycol monobutyl ether)

### Surfactant

Olfine E1010 (a product name, an acetylene glycol-based surfactant, manufactured by Nissin Chemical Co., Ltd.)
Surfynol 104 (a product name, an acetylene glycol-based surfactant, manufactured by Nissin Chemical Co., Ltd.)

### Resin

Superflex 420 (a product name, manufactured by DKS Co. Ltd.)

### pH Regulator

TEA (triethylamine)

### 2. Methods of Evaluation

### 2.1. Thickening Rate

Each of the ink compositions obtained above was mixed with an aqueous calcium solution (Ca concentration: 0.3 mol/L) at a ratio of 10:1, and the mixture was left to stand at 60° C. for 24 hours. From the viscosity η1 of the ink composition after being left to stand and the viscosity η0 of the ink composition in its initial state, a thickening rate was calculated as described below and evaluated. Thickening rate=ink viscosity η1 after being left to stand/initial ink viscosity η0

### Evaluation Criteria

A: The thickening rate was 1.5 or less.
B: The thickening rate was greater than 1.5 and 2.0 or less.
C: The thickening rate was greater than 2.0.

### 2.2. Color Developing Properties

Using a modified machine of a recording apparatus PX-S840 (a product name, manufactured by Seiko Epson Corporation), a magenta monochrome test pattern was recorded on a sheet of plain paper (manufactured by The Navigator Company) so as to give an ink application amount of 5.0 mg/inch². An OD value was measured using a colorimeter (manufactured by X-Rite, Inc., X-Rite i1) and was evaluated in accordance with the following criteria.

### Evaluation Criteria

A: The OD value was 0.85 or more.
B: The OD value was 0.75 or more and less than 0.85.
C: The OD value was 0.65 or more and less than 0.75.
D: The OD value was less than 0.65.

### 2.3. Redispersibility

The obtained ink composition and an aqueous calcium solution (Ca concentration: 0.3 mol/L) were mixed together at a ratio of 10:1, and five drops of 2 μl of the mixed liquid were dropped onto a glass slide and were dried at 60° C. for 24 hours. The glass slide after drying was immersed in a sample bottle in which only the ink composition before mixing was put and was left to stand for 3 minutes. Then, the sample bottle was turned upside down five times. The glass slide was taken out. A remaining mixed liquid on the glass and the degree of redissolution were visually determined in accordance with the following criteria.

### Evaluation Criteria

A: All the solid was redissolved and was not observed.
B: The solid became small, but some residues were observed.
C: The solid did not became small, almost all of which remained.
D: For the ink composition evaluated to be C, when a test was again conducted under the same conditions except that the drying temperature was changed to 40° C., the solid did not became small, almost all of which remained, as in the drying at 60° C.

### 2.4. Lightfastness

For the recorded product obtained in the above evaluation of color developing properties, a lightfastness test conforming to JEITA CP-3901B was conducted and was evaluated based on the calculated lifetime in accordance with the following criteria.

### Evaluation Criteria

A: 50 years or more
B: 30 years or more and less than 50 years
C: 10 years or more and less than 30 years
D: less than 10 years

### 2.5. Miscibility

The ink composition obtained above was put in a glass screw tube, which was lidded. The screw tube was left to stand in a thermostat chamber at 60° C. for 24 hours. Subsequently, the screw tube was taken out of the thermostat chamber. Whether the surfactant separated due to phase separation at the liquid level of the ink was checked and was evaluated in accordance with the following criteria.

### Evaluation Criteria

A: The separation of the surfactant was not observed.
B: The surfactant separated, and floating was observed at the liquid level.
C: The surfactant separated to be two layers.

### 3. Recording Test

The following two types of recording apparatuses were filled with the ink composition obtained above. Continuous printing was performed on a sheet of plain paper (manufactured by The Navigator Company).
A modified machine of a line system recording apparatus (LX-10050MF manufactured by Seiko Epson Corporation) as a line system recording apparatus as in FIG. 5, including a line head and an ink supply mechanism as in FIG. 4
A modified machine of a serial system recording apparatus (PX-M886FL manufactured by Seiko Epson Corporation) as a serial type recording apparatus changed from the above line system recording apparatus as described above

### 3.1. Ejection Stability

After performing filtration and deaeration, the recording apparatuses were filled with the ink, and a test pattern was continuously printed. For the line system recording apparatus, continuous printing was performed on 100 sheets of A4 paper (Navigator paper (plain paper)) at a speed of 60 pages/minute (ppm). The printing was single-sided printing. In the test pattern, 1×1 cm solid pattern was disposed in a checkered manner in a recordable area.

For the serial system recording apparatus, continuous printing was performed on 100 sheets of paper on single-sided printing at a speed of 30 pages/minute. The rest was the same as above. For the serial system printing apparatus, flushing was performed at a position at which the head was separated from the recording medium every one pass (one-time main scanning)

After the printing, a nozzle check pattern was printed. The number of nozzles in which distorted printing or non-ejection occurred was checked and was evaluated in accordance with the following criteria. A nozzle with a landing position deviation of half the distance between adjacent nozzles or more was determined to be distorted printing. Note that ejection stability is influenced by the viscosity (initial viscosity) of the ink, whether the amount of the ink supplied to the ink jet head is good enough, and the like.

### Evaluation Criteria

A: No nozzles with distorted printing or non-ejection occurred.
B: Nozzles with distorted printing or non-ejection occurred in less than 50% of the nozzles.
C: Nozzles with distorted printing or non-ejection occurred in 50% or more and less than 70% of the nozzles.
D: Nozzles with distorted printing or non-ejection occurred in 70% or more of the nozzles.

### 3.2. Clogging Recoverability

Continuous printing was performed in the same manner as in the above ejection stability test, in which it was continuously performed for 10 minutes.

Subsequently, with the ink jet head deviated from the position of a cap included in the printers and with the cap not mounted on the head, the printers were left to stand in an environment with a temperature of 40° C. and a humidity of 20% for 7 days. After being left to stand, every time a sucking operation of the ink within the nozzles was performed once as the cleaning of the ink jet head, the number of nozzles that could not eject the ink was counted, and the cleaning operation was repeated until all the nozzles recovered. Based on the number of times of cleaning required for the recovery of all the nozzles, evaluation was performed in accordance with the following evaluation criteria. Note that clogging recoverability is influenced by the degree of the occurrence of a dry solid of the ink in the nozzles, the composition of the dry solid, and the like.

### Evaluation Criteria

A: All the nozzles recovered by two-time cleaning or less.
B: All the nozzles recovered by three-time or four-time cleaning.
C: All the nozzles recovered by five-time or six-time cleaning.
D: Some nozzles did not recover even when six-time cleaning was performed.

### 4. Evaluation Results

Table 1 to Table 3 list the compositions of the inks used in the examples and their evaluation results. It is found from Table 1 to Table 3 that excellent ejection stability and clogging recoverability are achieved when recording is performed by the ink jet recording method including transporting a recording medium by a transport unit and ejecting an ink composition from an ink jet head to cause the ink composition to adhere to the recording medium that is being transported by the transport unit, wherein the ink jet head is a line head having a length of a recording area of the recording medium or more in a direction crossing a direction of the transporting, the recording medium is an absorbent recording medium, the ink composition is a red-based aqueous ink containing a pigment, the pigment contains an azo-based pigment, and a viscosity η1 of a mixed liquid when 10 parts by mass of the ink composition and 1 part by mass of an aqueous calcium propionate solution with a concentration of a Ca element of 0.3 mol/L are mixed together is less than 2.0 times a viscosity η0 of the ink composition.

Although not listed in the table, in the above clogging recoverability using the line system recording apparatus, the test was conducted in the same manner except that the continuous printing was performed on double-sided printing, and the evaluation result in Example 1 was B. This result revealed that double-sided printing increased the occurrence of paper dust in the process of inverting the recording medium, which affected clogging recoverability, but the present embodiment achieved excellent clogging recoverability.

What is claimed is:

1. An ink jet recording method comprising:
transporting a recording medium by a transport unit; and
ejecting an ink composition from an ink jet head to cause the ink composition to adhere to the recording medium that is being transported by the transport unit, wherein
the ink jet head is a line head having a length of a recording area of the recording medium or more in a direction crossing a direction of the transporting,
the recording medium is an absorbent recording medium,
the ink composition is a red-based aqueous ink containing a pigment,
the pigment contains an azo-based pigment, and
a viscosity η1 of a mixed liquid when 10 parts by mass of the ink composition and 1 part by mass of an aqueous calcium propionate solution with a concentration of a Ca element of 0.3 mol/L are mixed together is less than 2.0 times a viscosity η0 of the ink composition.

2. The ink jet recording method according to claim 1, wherein
a content of a solid content of the pigment is 0.5% by mass or more and 10% by mass or less with respect to a total mass of the ink composition.

3. The ink jet recording method according to claim 1, wherein
the pigment further contains a quinacridone-based pigment.

4. The ink jet recording method according to claim 1, wherein
the viscosity η1 is less than 1.5 times the viscosity η0.

5. The ink jet recording method according to claim 1, wherein
the ink composition contains a lactam-based compound, and
a content of the lactam-based compound is 0.5% by mass or more and 6.0% by mass or less with respect to a total mass of the ink composition.

6. The ink jet recording method according to claim 1, wherein
the ink composition contains an acetylene glycol-based surfactant.

7. The ink jet recording method according to claim 6, wherein
an HLB value of the acetylene glycol-based surfactant is 5 or less.

8. The ink jet recording method according to claim 1, wherein
the ink composition is a magenta ink.

9. The ink jet recording method according to claim 1, wherein
the azo-based pigment contains one or more selected from the group consisting of C.I.Pigment Red 150, C.I.Pigment Red 269, and C.I.Pigment Red 17.

10. The ink jet recording method according to claim 1, wherein
in the recording medium, a layer to absorb the ink composition contains a calcium salt.

11. The ink jet recording method according to claim 1, wherein
the ink composition contains a resin dispersant dispersing the pigment, and
an acid value of the resin dispersant is 250 mgKOH/g or less.

12. The ink jet recording method according to claim 1, wherein
a recording speed is 50 pages/minute or more.

13. An ink jet recording apparatus for obtaining a recorded product by the ink jet recording method according to claim 1, the ink jet recording apparatus comprising:
the ink composition;
the ink jet head; and
the transport unit.
